(19) United States
(12) Patent Application Publication
(10) Pub. No.: US 2012/0142324 A1
(43) Pub. Date: Jun. 7, 2012

(54) SYSTEM AND METHOD FOR PROVIDING CONFERENCE INFORMATION

(75) Inventors: Taesu Kim, Seoul (KR); Kisun You, Suwon (KR); Kyu Woong Hwang, Taejon (KR); Te-Won Lee, San Diego, CA (US)

(73) Assignee: QUALCOMM Incorporated, San Diego, CA (US)

(21) Appl. No.: 13/289,437

(22) Filed: Nov. 4, 2011

Related U.S. Application Data
(60) Provisional application No. 61/419,683, filed on Dec. 3, 2010.

(51) Int. Cl. H04M 3/42

(52) U.S. Cl. 455/416

(57) ABSTRACT

A method for providing information for a conference at one or more locations is disclosed. One or more mobile devices monitor one or more starting requirements of the conference and transmit input sound information to a server when the one or more starting requirements of the conference is detected. The one or more starting requirements may include a starting time of the conference, a location of the conference, and/or acoustic characteristics of a conference environment. The server generates conference information based on the input sound information from each mobile device and transmits the conference information to each mobile device. The conference information may include information on attendees, a current speaker among the attendees, an arrangement of the attendees, and/or a meeting log of attendee participation at the conference.

### CLAIM OF PRIORITY UNDER 35 U.S.C. §119

The present. Application for patent claims priority to Provisional Application No. 61/419,683 filed on Dec. 3, 2010, and assigned to the assignee hereof and hereby expressly incorporated by reference herein.

### TECHNICAL FIELD

The present disclosure relates generally to providing information for a conference at one or more locations. More specifically, the present disclosure relates to systems and methods for providing information for a conference to mobile devices by detecting one or more starting requirements of the conference in the mobile devices.

### BACKGROUND

In personal and business communications, meetings or conferences are often necessary. Specifically, a teleconference is widely used because of distance and inconvenience in traveling to a remote location where a meeting is held. For example, in the work setting, conferences involving two or more geographically distinct locations are often necessary for discussions and sharing opinions between people at geographically remote locations on a real-time basis.

Unfortunately, as conferences often require attendance of many unfamiliar people, conventional conferences are often inconvenient or confusing to the attendees because of lack of sufficient information on the attendees, such as the names, current speakers, arrangement of the attendees, etc. For example, when a person attends a business meeting with unfamiliar people, it may be difficult to identify or remember the names of other attendees during the meeting. In a teleconference setting involving two or more geographically remote locations, in particular, attendees may find it confusing and inconvenient to participate in the conference or remember the details of the conference without sufficient visual information. That is, in a teleconference scenario, since the attendees at one location cannot see the other remote attendees at other locations, they may not be able to identify or remember the other attendees at the other locations, or recognize a current speaker among the other attendees at a particular time. In addition, the attendees may not have access to information on activities of the other attendees at the other locations, e.g., the sitting arrangement of the other attendees, whether a particular attendee remains attending the conference or has quit the conference, or the like.

To address the above problems, visual sensors such as cameras and display devices such as televisions may be installed in each of the locations so that the images of the attendees at one location can be transmitted and displayed to the other attendees at the other location, and vice versa. However, such a solution generally requires additional hardware and costs. Further, the cameras and display devices may not be a complete solution to the above-described problems, especially when the attendees are not provided in advance with identification or profile information on other remote attendees. Furthermore, such an arrangement generally requires costly equipments, and often requires lengthy and complicated initial set up, which may not be convenient to ordinary users.

### SUMMARY

The present disclosure provides systems and methods for sharing a variety of information between attendees of a conference at one or more locations based on similarity of their surrounding sounds. Further, the systems and methods of the present disclosure provide information for a conference to one or more mobile devices by automatically generating the information upon detecting one or more starting requirements of the conference in each of the mobile devices.

According to one aspect of the present disclosure, a method for providing conference information in a mobile device is disclosed. The method includes monitoring, in a mobile device, one or more starting requirements of a conference at one or more locations. Input sound information is transmitted from the mobile device to a server when the one or more starting requirements of the conference is detected. Conference information is received from the server and the conference information is displayed on the mobile device. This disclosure also describes an apparatus, a combination of means, and a computer-readable medium relating to this method.

According to another aspect of the present disclosure, a mobile device for providing conference information is provided. The mobile device includes an initiating unit, a transmitting unit, a receiving unit, and a display unit. The initiating unit is adapted to monitor one or more starting requirements of a conference at one or more locations. The transmitting unit is configured to transmit input sound information to a server when the one or more starting requirements of the conference is detected. Further, the receiving unit is configured to receive conference information from the server, and the display unit is adapted to display the conference information.

According to yet another aspect of the present disclosure, a method for providing conference information in a system having a server and a plurality of mobile devices is disclosed. In this method, one or more mobile devices monitor one or more starting requirements of a conference at one or more locations, and transmit input sound information to the server when the one or more starting requirements of the conference is detected. The server generates conference information based on the input sound information from each mobile device and transmits the conference information to each mobile device. The conference information is displayed on each mobile device. This disclosure also describes an apparatus, a combination of means, and a computer-readable medium relating to this method.

### BRIEF DESCRIPTION OF THE DRAWINGS

FIG. 1 illustrates a system including a plurality of mobile devices and a server for generating and providing conference information according to one embodiment of the present disclosure.

FIG. 2 depicts an exemplary configuration of a mobile device according to one embodiment of the present disclosure.

FIG. 3 depicts an exemplary configuration of a server according to one embodiment of the present disclosure.

FIG. 4 shows a flowchart of a method, performed by a mobile device, of transmitting input sound information to a server and receiving conference information from the server according to one embodiment of the present disclosure.

FIG. 5 illustrates a flowchart of a method, performed by a server, of receiving input sound information from each mobile device and providing conference information to each mobile device according to one embodiment of the present disclosure.

FIG. 6 illustrates a flowchart of a method, performed by a server, of determining attendees at a conference according to one embodiment of the present disclosure.

FIG. 7A shows an exemplary screen of a mobile device displaying information on the attendees.

FIG. 7B shows another exemplary screen of a mobile device displaying information on the attendees.

FIG. 8A illustrates a flowchart of a method, performed by a mobile device, of initiating transmitting input sound information to a server when a starting requirement is detected according to one embodiment of the present disclosure.

FIG. 8B illustrates a flowchart of a method, performed by a mobile device, of initiating transmitting input sound information to a server when more than one starting requirements are detected according to one embodiment of the present disclosure.

FIG. 9A illustrates a flowchart of a method, performed by a server, of determining a current speaker among attendees at a conference based on a sound level of an input sound of each mobile device according to one embodiment of the present disclosure.

FIG. 9B illustrates a sound level diagram of input sounds of a subset of mobile devices, over a period of time.

FIG. 10A illustrates a flowchart of a method, performed by a server, of determining a current speaker among attendees at a conference based on voice activity information of each mobile device according to one embodiment of the present disclosure.

FIG. 10B illustrates a diagram of a ratio of a current input sound level to an average input sound level of each mobile device, over a period of time.

FIG. 11A illustrates a flowchart of a method, performed by a server, of determining a current speaker among attendees at a conference based on voice activity information of each mobile device according to one embodiment of the present disclosure.

FIG. 11B illustrates a diagram of a probability that an input sound of each mobile device matches acoustic characteristics of the voice of a user of the mobile device, over a period of time.

FIG. 12A illustrates a method of calculating, performed by a server, an arrangement of attendees according to one embodiment of the present disclosure.

FIG. 12B illustrates an example of the arrangement of the attendees displayed on a mobile device.

FIG. 13 shows an example of a meeting log of a conference including attendee participation information

FIG. 14 shows a block diagram of a design of an exemplary mobile device in a wireless communications system.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

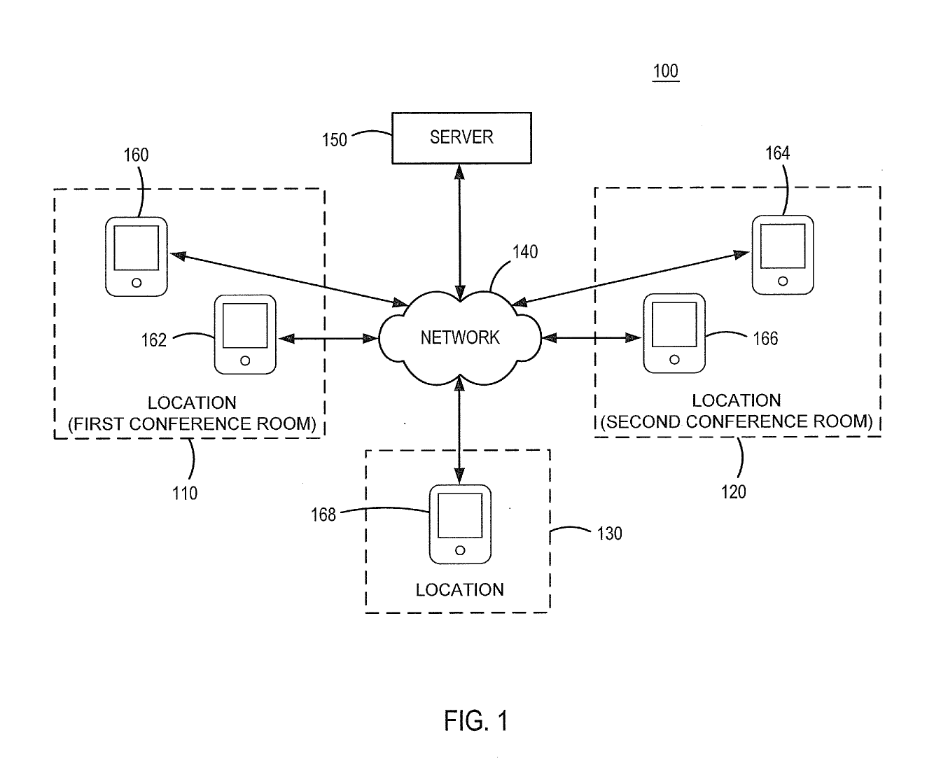

FIG. 1 illustrates a system 100 including a plurality of mobile devices 160, 162, 164, 166, and 168, and a server 150 configured to generate and provide conference information according to one embodiment of the present disclosure. The mobile devices 160, 162, 164, 166, and 168, and the server 150 communicate with each other through a wireless network 140. The mobile devices 160 and 162 are located in one geographic location 110, e.g., a first conference room in a city. On the other hand, the mobile devices 164 and 166 are located in another geographic location 120, e.g., a second conference room in another city. The mobile device 168 is located in still another geographic location 130, e.g., a location outside the first and second conference rooms such as on a street.

In the illustrated embodiment, the mobile devices 160, 162, 164, 166, and 168 are presented only by way of examples, and thus the number of mobile device(s) located in each location or the number of location(s) may be changed depending on individual conference settings. The mobile devices may be any suitable device such as a cellular phone, smartphone, laptop computer, or tablet personal computer equipped with a sound capturing capability, e.g., a microphone, and communication capability through a data and/or communication network.

The system 100 is configured to generate a variety of information associated with a conference based on input sounds received by the mobile devices 160, 162, 164, 166, and 168 and to provide the information to attendees of the conference, e.g., at least one of the mobile device users. In one conference scenario, only the users of the mobile devices 160 and 162 both located at the location 110 attend a conference without involving other users at remote locations such as the locations 120 and 130. In another conference scenario, the users of the mobile devices 160 and 162 located in the location 110 attend a teleconference with the users of the mobile devices 164 and 166 located in a remote location such as the location 120. In such a scenario, the users of the mobile devices 160, 162, 164, and 166 attend the teleconference using a teleconference system (not shown) which are implemented with conventional teleconference phones and a teleconference equipment capable of exchanging sound between the teleconference phones at the remote locations. The teleconference phones and equipment may be operated separately from the mobile devices 160, 162, 164, 166, and 168, the network 140, and the server 150 of the system 100. Further, in yet another conference scenario, the users of the mobile devices 160 and 162 may start a local conference for internal or preliminary discussion between them at the location 110, prior to joining a teleconference with the users of the mobile devices 164 and 166 at the remote location 120. Meanwhile, the user of the mobile device 168 located in the location 130 geographically separate and distant from the locations 110 and 120, e.g., a street, is not involved in any conferences between the users of the mobile devices 160, 162, 164, and 166.

Although the two locations 110 and 120 are geographically remote from each other, if the users at the two locations are in communication with each other through the teleconference system, surrounding ambient sounds and voices generated in each location and respectively inputted to the mobile devices 160, 162, 164, and 166 may be similar to each other. Specifically, a sound generated within the location 110 is transmitted into the location 120 through the teleconference phones (not shown). Similarly, another sound generated within the location 120 is transmitted into the location 110 through the teleconference phones. As a result, in the location 110, the sound generated therein and the sound transmitted from the location 120 are inputted into the mobile devices 160 and 162. Similarly, in the location 120, the sound generated therein and the sound transmitted from the location 110 are inputted into the mobile devices 164 and 166. As a result, the input sounds of the mobile device 160, 162, 164, and 166 may be similar to each other.

Meanwhile, the user of the mobile device 168 located in the location 130 is not involved in any teleconferences. Thus, the mobile device 168 does not receive any voices input to the mobile devices 160, 162, 164, and 166 or ambient sounds emanating from the location 110 or 120 during the teleconference. Accordingly, the input sound of the mobile device 168 may not be similar to those of the mobile devices 160, 162, 164, and 166.

In one embodiment, each of the mobile devices 160, 162, 164, 166, and 168 transmits its input sound information to the server 150 through the network 140. The input sound information may include, but not limited to, any suitable representation of the input sound of each mobile device, sound signature extracted from the input sound, sound level, voice activity information, etc. Based on the input sound information from the mobile devices, the server 150 generates and provides conference information to the mobile devices 160, 162, 164, and 166, and if necessary, to the mobile device 168. The conference information includes information on attendees of the conference at one or more locations such as identification and location of the attendees, an arrangement of the attendees, and/or a meeting log of the conference including attendee participation information, which will be described in detail below.

As one exemplary setting where the server 150 is operated to generate the conference information above, it is assumed that the mobile devices 160, 162, 164, 166, and 168 are carried by their respective users or located near the users. It is also assumed that a mobile device is placed closer to its user than the users of other mobile devices. For example, the mobile device 160 is placed closer to its user than the user of the mobile device 162 in the first conference room. Similarly, the mobile device 164 is placed closer to its user than the user of the mobile device 166 in the second conference room.

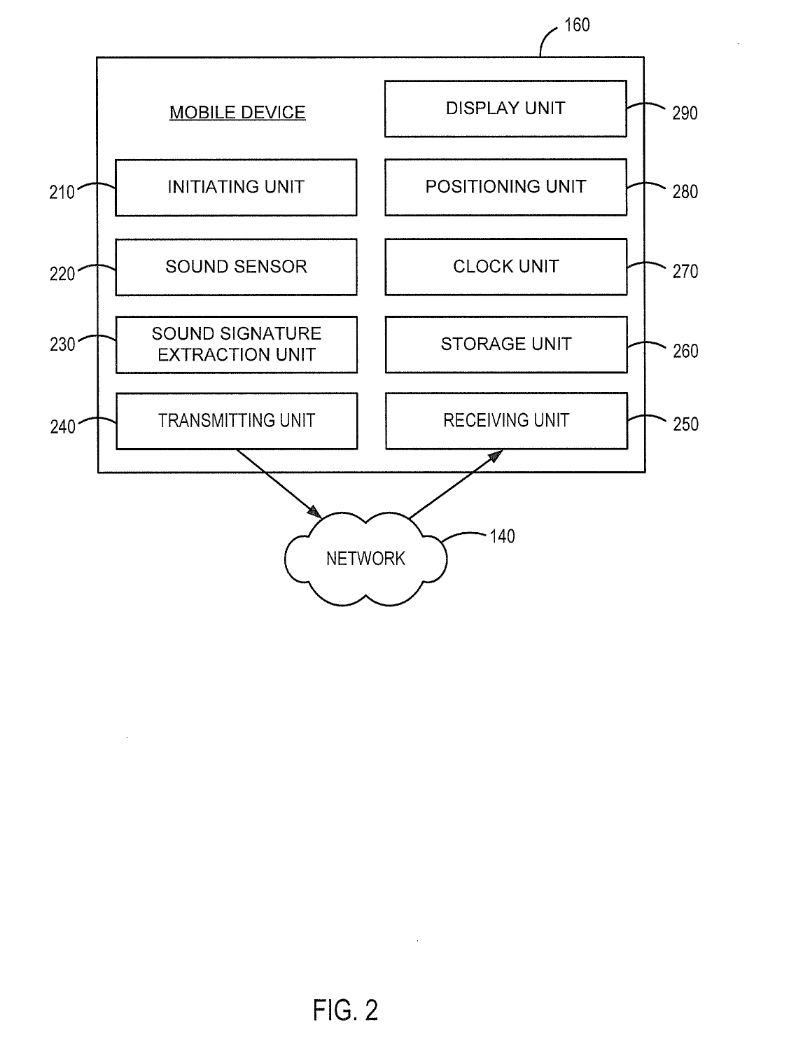

FIG. 2 illustrates an exemplary configuration of the mobile device 160 according to one embodiment of the present disclosure. As shown in FIG. 2, the mobile device 160 includes an initiating unit 210, a sound sensor 220, a sound signature extraction unit 230, a transmitting unit 240, a receiving unit 250, a storage unit 260, a clock unit 270, a positioning unit 280, and a display unit 290. Although the configuration of the mobile device 160 is shown in FIG. 2, the same configuration may also be implemented in other mobile devices 162, 164, 166, and 168. The above described units in the mobile device 160 may be implemented by hardware, software executed in one or more processors, and/or the combination thereof.

The initiating unit 210 monitors one or more starting requirements of a particular conference and determines whether the one or more starting requirements is detected. The sound sensor 220 (e.g., microphone) is configured to receive and sense the sound around the mobile device 160. The sound signature extraction unit 230 extracts a sound signature, i.e., a unique or distinguishable characteristic, from the sound. The clock unit 270 monitors the current time of the mobile device 160, and the positioning unit 280 estimates the current location of the mobile device 160 using, e.g., Global Positioning System (GPS). The transmitting unit 240 transmits information, e.g., input sound information, to the server 150 through the network 140, and the receiving unit 250 receives conference information from the server 150 through the network 140. The display unit 290 displays various information, e.g., the conference information received from the server 150. The storage unit 260 stores various information needed to process the input sound, input sound information, location, time, conference information, etc.

The sound sensor 220 may include, e.g., one or more microphones or any other type of sound sensors used to capture, measure, record, and/or convey any aspect of the captured input sound of the mobile device 160. Some embodiments may take advantage of sensors already used in the daily operation of the mobile device 160 such as microphones used to convey a user's voice during a telephone call. That is, the sound sensor 220 may be practiced without requiring any modification of the mobile device 160. Also, the sound sensor 220 may employ additional software and/or hardware to perform its functions in the mobile device 160.

Further, the sound signature extraction unit 230 may use any suitable signal processing scheme, including speech compression, enhancement, recognition, and synthesis methods to extract the sound signature of input sound. For example, such signal processing scheme may employ MFCC (Mel-frequency cepstral coefficients), LPC (linear predictive coding), and/or LSP (line spectral pair) techniques, which are well-known methods for speech recognition or speech codec.

In one embodiment, a sound signature may include multiple components, which are represented as a vector having n-dimensional values. Under the MFCC method, for example, a sound signature may include 13 dimensions with each dimension represented as a 16 bit value. In this case, the sound signature is 26 bytes long. In another embodiment, the sound signature may be binarized so that each dimension is represented as a 1 bit binary value. In such a case, the binarized sound signature may be 13 bits long.

A sound signature may be extracted from an input sound under the MFCC method as follows. A frame of an input sound in the time domain (e.g., raw sound signal) is multiplied by a windowing function, e.g., hamming window. Thereafter, the sound signal is Fourier transformed to the frequency domain, and then a power is calculated for each band in the spectrum of the transformed signal in the frequency domain. A logarithm operation and a discrete cosine transform (DCT) operation are performed on each calculated power to obtain DCT coefficients. A mean value over a period of a predetermined time in the past is subtracted from each DCT coefficient for binarization and a set of the binarization results constitutes the sound signature.

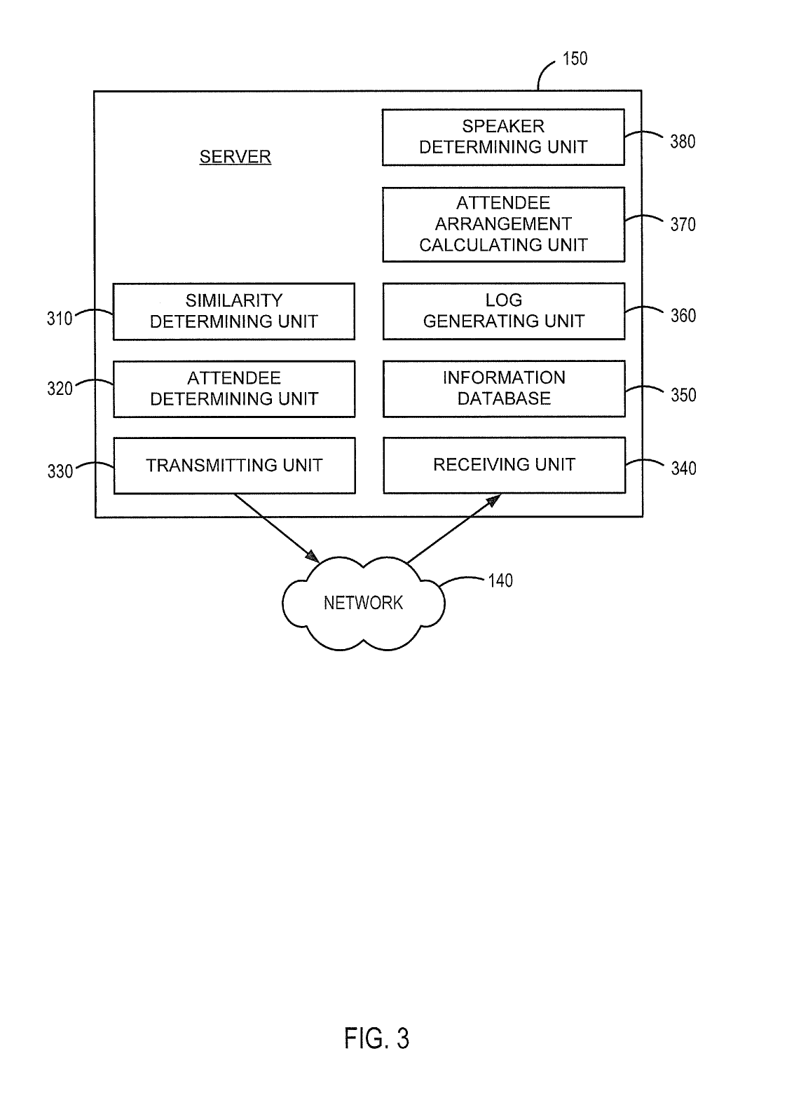

FIG. 3 illustrates an exemplary configuration of the server 150 according to one embodiment of the present disclosure. As shown in FIG. 3, the server 150 includes a similarity determining unit 310, an attendee determining unit 320, a transmitting unit 330, a receiving unit 340, an information database 350, a log generating unit 360, an attendee arrangement calculating unit 370, and a speaker determining unit 380. The server 150 may be implemented by a conventional computer system executing the methods of the present disclosure with a communication capability over the network 140. The server 150 may be used in a system for providing cloud computing services to the mobile devices 160, 162, 164, 166, and 168 and other client devices. Further, one of the mobile devices 160, 162, 164, 166, and 168 may be configured to function as the server 150 when the mobile devices communicate directly with each other, e.g., using Wi-Fi Direct, Bluetooth, or FlashLinq technology, without an additional external server. The server 150 may also be implemented in any one of the teleconference phones and equipment that are operated for conducting a teleconference associated with the mobile devices 160, 162, 164, 166, and 168. The above described units in the server 150 may be implemented by hardware, software executed in one or more processors, and/or the combination thereof.

The receiving unit 340 is configured to receive information, e.g., input sound information, from each of the mobile devices 160, 162, 164, 166, and 168. The similarity determining unit 310 determines degrees of similarity between input sound information from the mobile devices 160, 162, 164, 166, and 168. The attendee determining unit 320 determines attendees at the conference based on the degrees of similarity. The log generating unit 360 generates a meeting log of the conference including attendee participation information. Further, the attendee arrangement calculating unit 370 calculates the arrangement of the attendees at each location of the conference. The speaker determining unit 380 determines a current speaker among the attendees at a particular time. The transmitting unit 330 is configured to transmit conference information including the above information to each of the mobile devices 160, 162, 164, and 166, and if necessary, to the mobile device 168. The information database 350 may be configured to store various information including the above information and any other information needed for processing the above information.

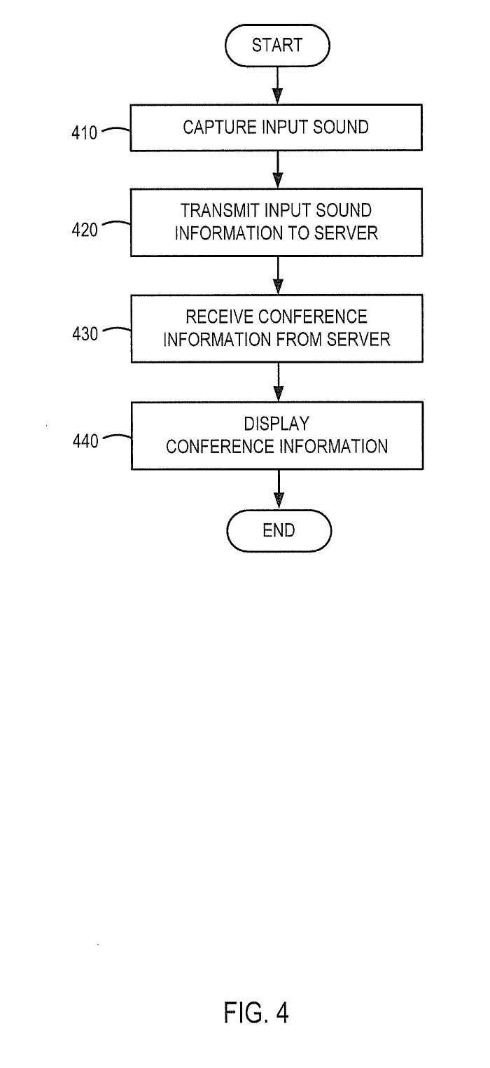

FIG. 4 illustrates a flowchart of a method, performed by a mobile device, of capturing and transmitting input sound information to the server 150 and displaying conference information from the server 150 according to one embodiment of the present disclosure. In FIG. 4, the sound sensor 220 of the mobile device 160 captures input sound and outputs the captured sound in analog or digital format, at 410. The input sound may include ambient sound around the mobile device 160 and voices from the user of the mobile device 160 and others nearby.

The transmitting unit 240 in the mobile device 160 transmits input sound information associated with the input sound through the network 140 to the server 150, at 420. A transmitting unit in each of the other mobile devices 162, 164, 166, and 168 also transmits input sound information associated with input sound captured by the respective sound sensors through the network 140 to the server 150.

The transmitting unit 240 may also transmit information relating to the user and the mobile device 160 including, but not limited to, identification information, time information, and location information. For example, the identification information may include a product number, serial number, ID of the mobile device 160, user name, user profile, etc. The time information may include a current time or a time when the input sound is captured, which may be monitored by the clock unit 270. The location information may include a geographic location of the mobile device 160, which may be estimated by the positioning unit 280, when the input sound is captured. Some of the above information may be pre-stored in the storage unit 260 of the mobile device 160.

The receiving unit 250 in the mobile device 160 receives conference information from the server 150, at 430. The display unit 290 displays the conference information according to a desired display format, at 440.

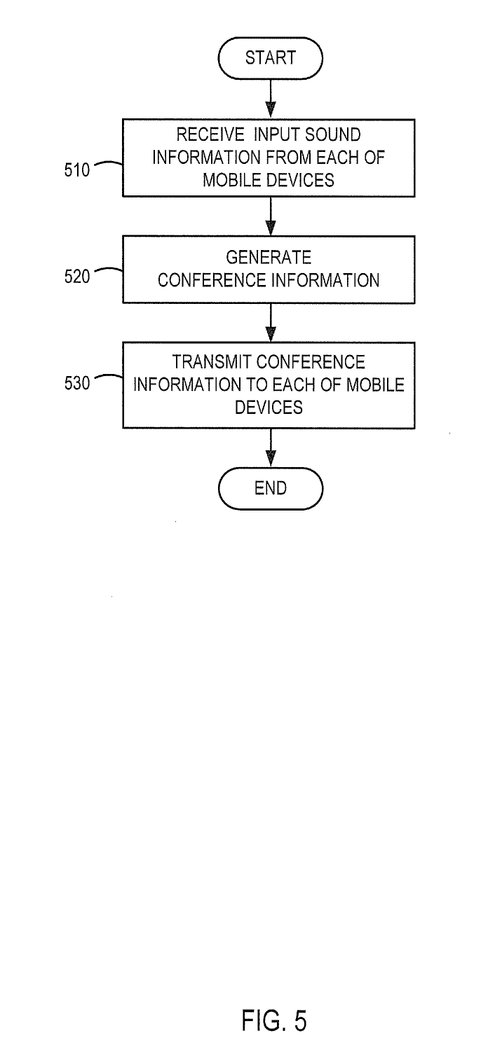

FIG. 5 illustrates a flowchart of a method, performed by the server 150, of receiving input sound information from each mobile device and providing conference information to each mobile device according to one embodiment of the present disclosure. In FIG. 5, the receiving unit 340 of the server 150 receives the input sound information from each of the mobile devices 160, 162, 164, 166, and 168, at 510. The receiving unit 340 may further receive the various information as described above. Such information received by the receiving unit 340 may be stored in the information database 350.

The server 150 generates conference information for a conference involving at least some of the mobile devices 160, 162, 164, 166, and 168 based on the received information, at 520. For example, at least one of the similarity determining unit 310, the attendee determining unit 320, the information database 350, the log generating unit 360, the attendee arrangement calculating unit 370, the speaker determining unit 380 may be used in generating the conference information.

When conference information is generated, the server 150 transmits, via the transmitting unit 330, the conference information to each of the mobile devices 160, 162, 164, and 166, and if necessary, to the mobile device 168, at 530. If a subset of the mobile devices is in the conference, the server 150 may transmit the conference information to those mobile devices. For example, the server 150 may not send the conference information to the mobile device 168, whose user is not participating in the conference.

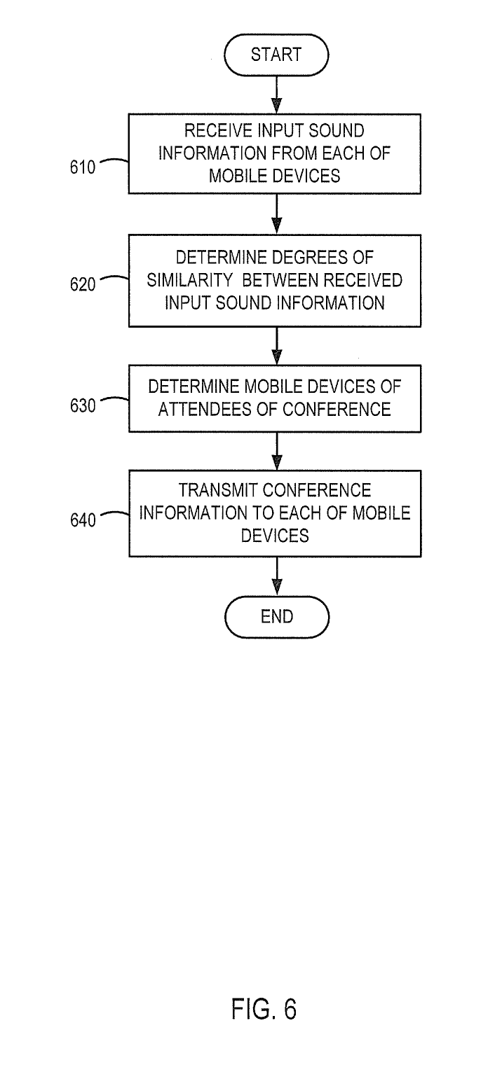

The detailed operations of the server 150 and the mobile devices 160, 162, 164, 166, and 168 according to embodiments of the present disclosure will be described below with reference to FIGS. 6 to 13.

FIG. 6 illustrates a flowchart of a method, performed by the server 150, of determining attendees at a conference according to one embodiment of the present disclosure. The receiving unit 340 of the server 150 receives the input sound information associated with the captured input sound from each of the mobile devices 160, 162, 164, 166, and 168, at 610. The similarity determining unit 310 determines a degree of similarity between input sounds of each pair of the plurality of mobile devices 160, 162, 164, 166, and 168 based on the input sound information by comparing the input sound information from each pair of the mobile devices, at 620.

In one embodiment of the present disclosure, a degree of similarity between the input sounds of two mobile devices, e.g., an m-th mobile device and an n-th mobile device, may be determined based on a Euclidean distance between vectors respectively representing the sound signatures of the input sounds of the two mobile devices, e.g., according to the following equation:

$$Euclidean Distance = {\sum }_{i} {\vert a [ i ] - b [ i ] \vert}^{2}$$

where a[i] indicates an i-th dimension value of a vector a representing the sound signature of the m-th mobile device, and b[i] indicates an i-th dimension value of a vector b representing the sound signature of the n-th mobile device.

The degree of similarity between the input sounds of the two mobile devices may be determined based on a Euclidean distance between a pair of sound signature sequences that are extracted over a period of time at predetermined time intervals. If a sequence of sound signatures is extracted at time intervals of 10 ms over a period of 1 sec in each of the m-th and n-th mobile devices, the server 150 will receive one hundred pairs of sound signatures from the mobile devices. In this case, a Euclidean distance for each pair of sound signatures from the m-th and n-th mobile devices is calculated and the degree of similarity is determined based on a mean value of the Euclidean distances. For example, the degree of similarity may be a reciprocal of the mean value or a log-scaled value of the reciprocal.

Based on the degrees of similarity, the attendee determining unit 320 in the server 150 determines a subset of mobile devices whose users are attending the same conference among all of the plurality of mobile devices, which transmitted the input sound information to the server 150, at 630. For example, a mobile device of a user attending a particular conference can be considered to have a greater degree of similarity with another mobile device in the same conference than with another mobile device not in the same conference. Once the mobile devices which are in the conference have been determined, the attendee determining unit 320 identifies the users of the determined mobile devices based on the information relating to the mobile devices and the associated users, and determines them to be the attendees at the conference.

The server 150 generates conference information including information on the attendees, which may include at least one of identification information, location information of each attendee, etc. Then, the transmitting unit 330 of the server 150 transmits the conference information to the subset of mobile devices which have been determined to be in the conference, at 640.

In some embodiments, mobile devices having degrees of similarity greater than a predetermined similarity threshold may be determined to belong to the conference group, while other mobile devices having degrees of similarity less than or equal to the similarity threshold may be determined not to belong to the conference group. The predetermined similarity threshold may be configured according to the needs of the system 100 and pre-stored in the information database 350 of the server 150.

The following is a more detailed procedure of determining the degrees of similarity and determining the attendees at a conference based on the degrees of similarity according to one embodiment.

Referring back to FIG. 1, the mobile devices 160, 162, 164, 166, and 168 respectively transmit their input sound information to the server 150. The similarity determining unit 310 of the server 150 determines the degree of similarity between the input sound information of each of the mobile devices 160, 162, 164, 166, and 168 and the input sound information of each of the other mobile devices. For example, the similarity determining unit 310 evaluates a degree of similarity between the input sound information of the mobile device 160 and that of each of the other mobile devices 162, 164, 166, and 168. Similarly, a degree of similarity is determined between the input sound information of the mobile device 162 and that of each of the other mobile devices 164, 166, and 168.

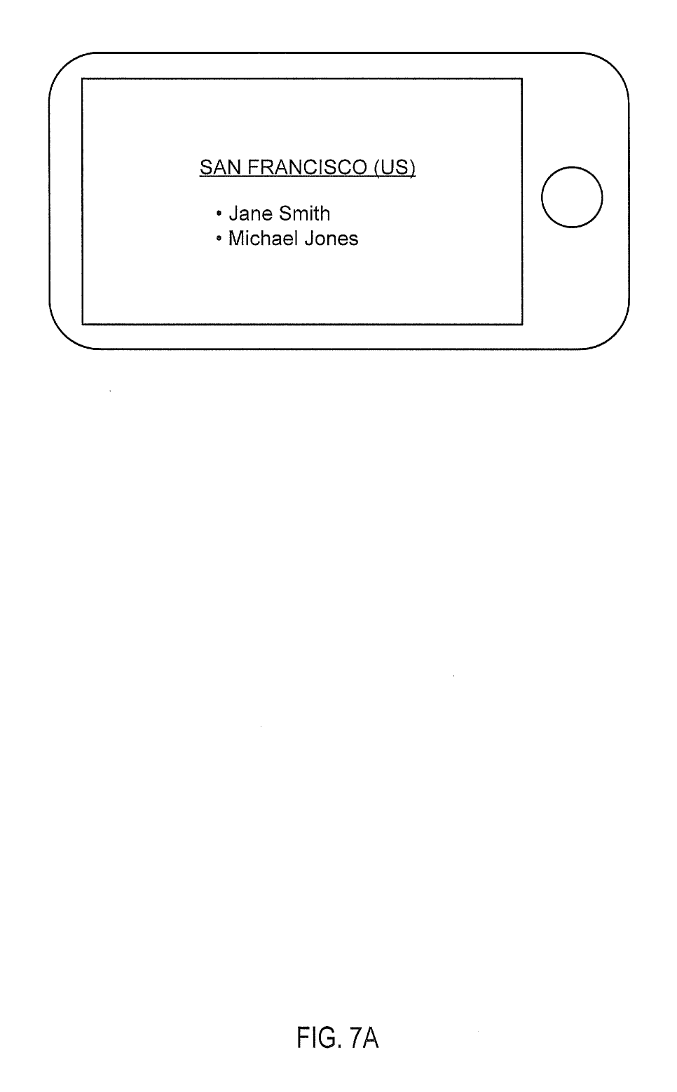

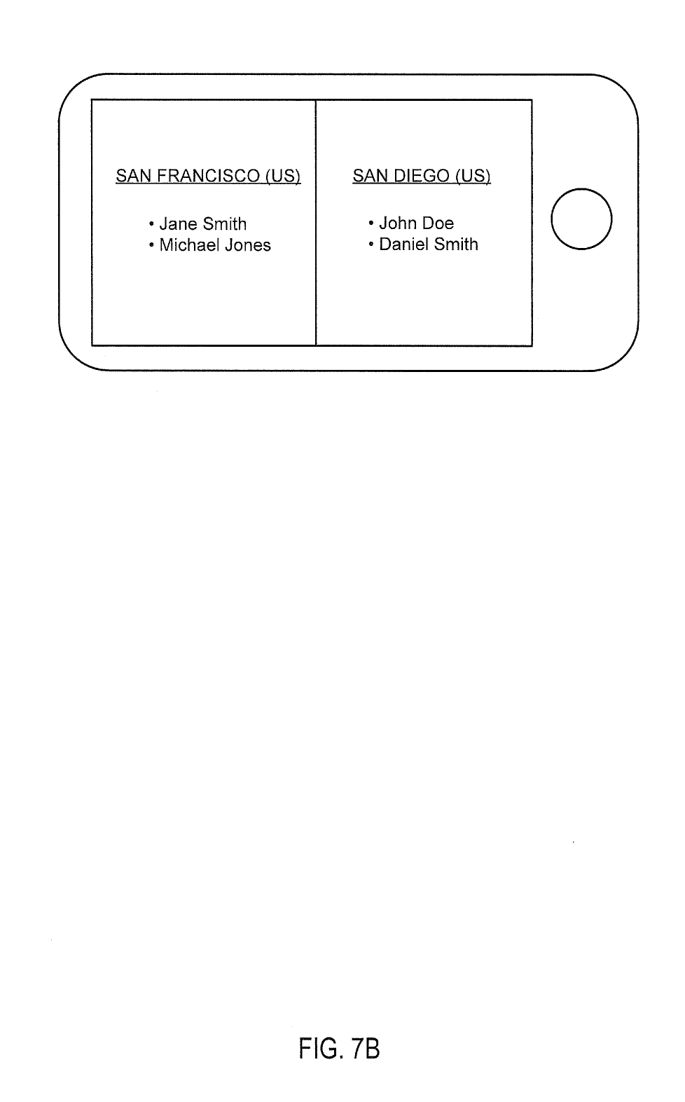

In a first conference scenario in FIG. 1, it is assumed that the users of the mobile devices 160 and 162, located at the same location, attend a conference, while the other users of the other mobile devices 164, 166, and 168 do not attend the conference. Such a conference may be a preliminary conference before the main conference, in which additional users may join. In this preliminary conference between the users of the mobile devices 160 and 162, the degree of similarity of the input sound information between the mobile device 160 and the mobile device 162 will be greater than the degrees of similarity associated with other mobile devices 164, 166, and 168. In the case where a similarity threshold is used, the degree of similarity of the input sound information between the mobile device 160 and the mobile device 162 may be greater than the similarity threshold, while the other degrees of similarity may not be greater than the similarity threshold. As a result, the attendee determining unit 320 of the server 150 determines that the users of the mobile devices 160 and 162 attend the same conference. Upon receiving the conference information transmitted from the server 150, a display unit of each mobile device as shown in FIG. 2, may display the conference information. For example, in the first conference scenario, the users of the mobile devices 160 and 162 may be displayed on the display unit with their location and names, as shown in FIG. 7A.

In a second conference scenario, it is assumed that the users of the mobile devices 160 and 162 at the location 110 and the users of the mobile devices 164 and 166 located at the location 120 attend a same conference from their respective locations. The user of the mobile device 168 remains in location 130 and does not attend the conference. Such a conference may be a main conference after the preliminary one such as the first scenario above, and may be a telephone conference, video conference, etc.

As describe above, the degrees of similarity of the input sound information for the mobile device 160 with respect to that of each of the other mobile devices 162, 164, 166, and 168 are determined. Since the mobile devices 160, 162, 164, and 166 are in the same conference with similar input sounds, the degree of similarity of the input sound information between each pair of the mobile devices 160, 162, 164, and 166, which are in the conference, will be greater than the degree of similarity of the input sound information between the mobile device 168 and each of the mobile devices 160, 162, 164, and 166. In the case where a similarity threshold is used, the degree of similarity of the input sound information between each pair of the mobile devices 160, 162, 164, and 166 may be greater than the similarity threshold, while the other degrees of similarity may not be greater than the similarity threshold. As a result, the attendee determining unit 320 determines that the users of the mobile devices 160, 162, 164, and 166 attend the same conference. In this case, the users of the mobile devices 160, 162, 164, and 166 may be displayed on the display unit of each of the mobile devices with the locations and names of the attendees, as shown in FIG. 7B.

According to one embodiment of the present disclosure, the operation of transmitting the input sound information by the mobile device may be automatically initiated if one or more starting requirements of a conference is detected. In general, one or more starting requirements for a conference may be deter mined prior to the conference, such as an attendee list, a starting time for the conference, a conference location (e.g., a plurality of conference rooms when the conference is a teleconference), and the like. Each user of a mobile device may input and store the conference starting requirements. Additionally or alternatively, a conference scheduling application according to the present disclosure may obtain conference starting requirement information from another application, e.g., a calendar application, a schedule management application such as MS Outlook™ program, or the like, running on the mobile device or an external device such as a personal computer.

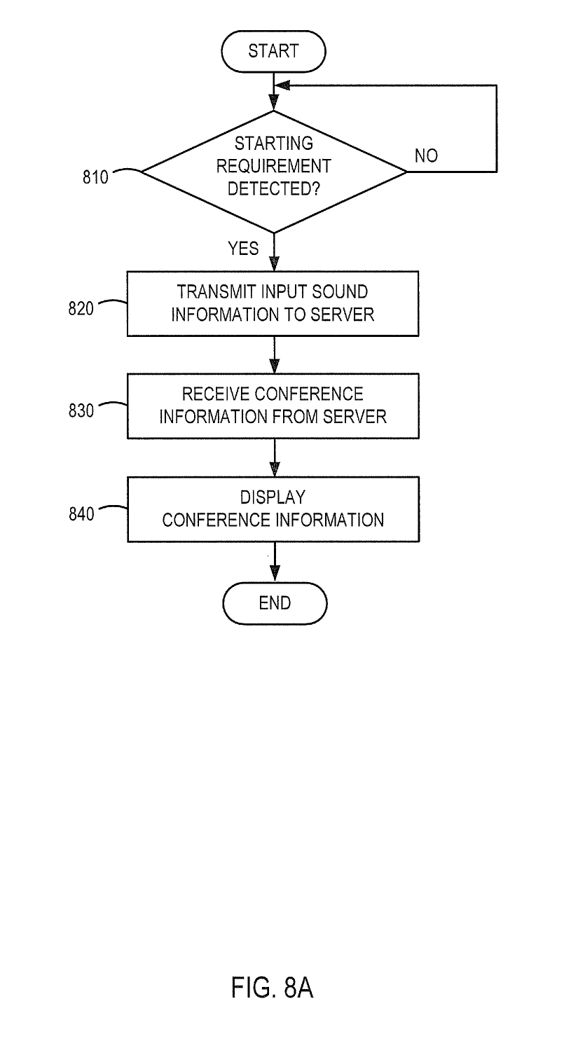

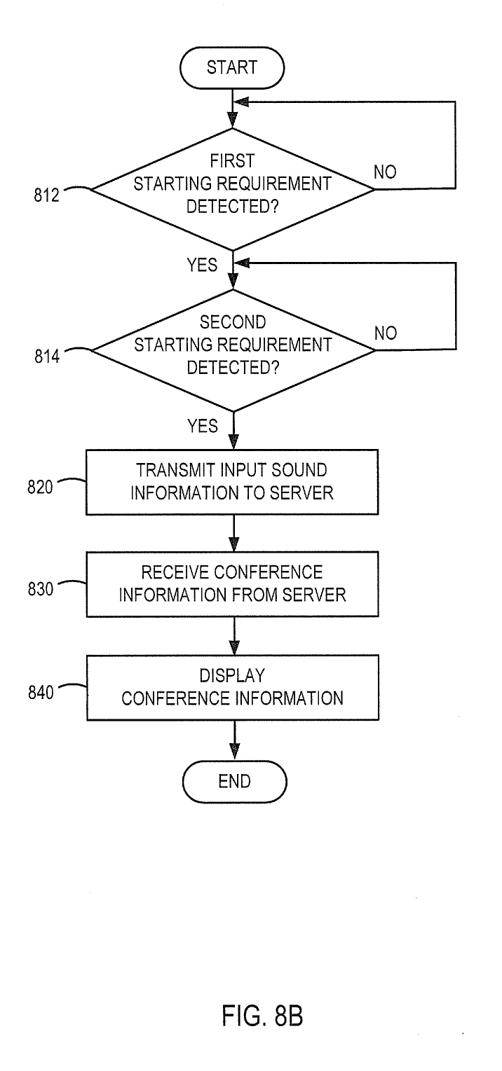

FIG. 8A shows a flowchart of a method, performed by the mobile device 160, of initiating a transmission of input sound information to the server 150 when a starting requirement is detected according to one embodiment of the present disclosure. Although the method in FIG. 8A is illustrated as being performed by the mobile device 160, it should be appreciated that other mobile devices 162, 164, 166, and 168 may also perform the method. In this method, the initiating unit 210 of the mobile device 160 monitors a starting requirement to determine whether the starting requirement is detected, at 810. If the starting requirement is not detected (“NO” at 810), the initiating unit 210 continues to monitor the starting requirement. If the starting requirement is detected (“YES” at 810), the transmitting unit 240 starts transmitting input sound information of the mobile device 160 to the server 150, at 820. Upon receiving the input sound information from the mobile device 160 and from one or more mobile devices 162, 164, 166, and 168, the server 150 generates conference information based on the input sound information from each mobile device. The server 150 then transmits the conference information to the mobile device 160 and, if necessary, each of the other mobile devices. The receiving unit 250 of the mobile device 160 receives the conference information from the server 150, at 830. The display unit 290 of the mobile device 160 then displays the conference information for the user, at 840.

The starting requirement may specify a condition to initiate transmission of input sound information. For example, the starting requirement may be a starting time, one or more conference locations, acoustic characteristics of a conference environment, or the like. The starting requirement may be stored in each mobile device by the user to be automatically operational when the mobile device detects one or more starting requirements. For example, the starting requirement may be met when the current time of the mobile device 160, which may be monitored by the clock unit 270, reaches the starting time of a conference. Similarly, the starting requirement may be met when the current location of the mobile device 160, which may be estimated by the positioning unit 280, is determined to be a location for a conference, e.g., a conference room. In some embodiments, the location requirement may be satisfied when the current location of the mobile device 160 is determined to be within a predetermined range, e.g., twenty meters, from a specified conference location.

Further, a sound representative of a conference environment may also be used as a starting requirement. According to one embodiment, a conference environment is distinguished based on acoustic characteristics. For example, the conference environment can be characterized by voices of conference attendees that can be included in the sound inputted to mobile devices present in the conference. The maximum number of conference attendees, i.e., mobile device users, whose voices are input to the mobile devices may be set to a predetermined threshold. Also, the level of allowable background sound, which may refer to noise, included in the input sound may be set to a predetermined sound level threshold. If either the maximum number of conference attendees exceeds the predetermined threshold or the level of background sound exceeds the sound level threshold, the starting requirement will not be detected. Further, the allowable reverberation time of the input sound may be set to a predetermined time period (e.g., 200 to 500 ms), which falls into a range of reverberation time measurable in a conference room of a suitable size.

According to another embodiment, an acoustic model of a conference environment may be used as a starting requirement. In this case, a variety of conference environments are trained through a modeling methodology such as GMM (Gaussian Mixture Model) method or HMM (Hidden Markov Model) method to obtain the acoustic model representative of the conference environment. Using such an acoustic model, the starting requirement is detected when the input sound of the mobile device corresponds to the acoustic model. For example, the starting requirement may be detected when a degree of similarity between the input sound and the acoustic model is greater than a predetermined similarity threshold.

FIG. 8B shows a flowchart of a method, performed by a mobile device, of initiating a transmission of input sound information to the server 150 when more than one starting requirements are detected according to one embodiment of the present disclosure. In FIG. 8B, two starting requirements, i.e., a first starting requirement and a second starting requirement, are monitored by the initiating unit 210 of the mobile device 160. If the first starting requirement is not detected (“NO” at 812), the initiating unit 210 continues to monitor the first starting requirement. If the first starting requirement is detected (“YES” at 812), the second starting requirement is monitored. If the second starting requirement is not detected (“NO” at 814), the initiating unit 210 continues to monitor the second starting requirement. If the second starting requirement is detected (“YES” at 814), the transmitting unit 240 of the mobile device 160 starts transmitting the input sound information to the server 150, at 820. Upon receiving the input sound information from the mobile device 160, the server 150 generates and transmits the conference information to the mobile device 160 as described above. The receiving unit 250 of the mobile device 160 receives the conference information from the server 150, at 830. The display unit 290 of the mobile device 160 then displays the conference information for the user, at 840.

Although FIG. 8B illustrates monitoring the two starting requirements, the number of starting requirements monitored may be more than two. Further, although FIG. 8B illustrates monitoring the two starting requirements sequentially, the starting requirements may be monitored parallel to each other and, the transmitting unit 240 may start transmitting the input sound information to the server 150 when one or more of the starting requirements are determined to be detected.

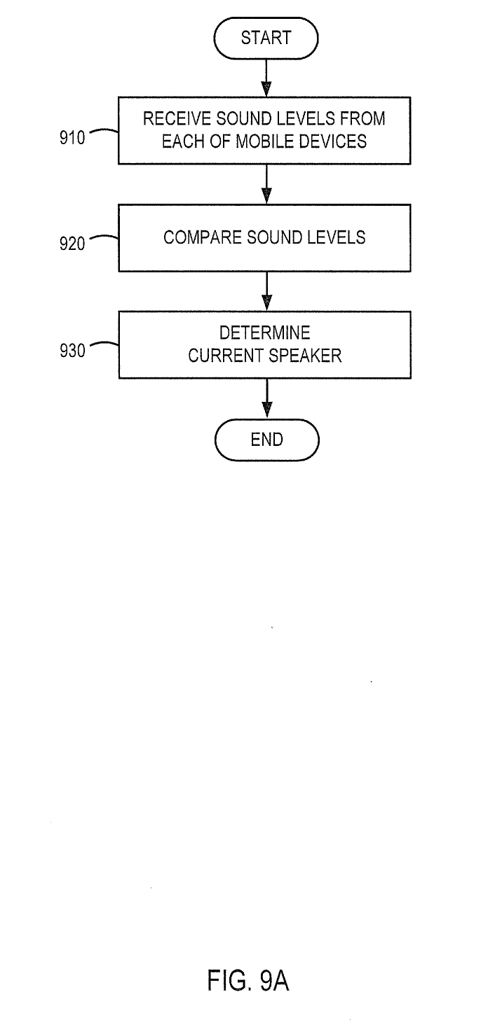

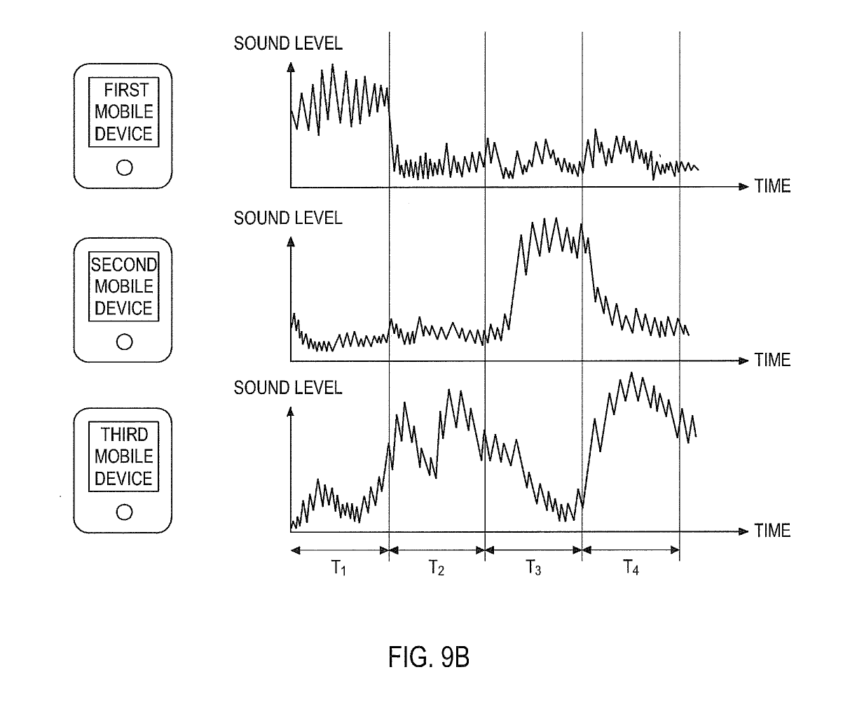

In another embodiment of the present disclosure, the server 150 determines a current speaker among attendees at a conference at a particular time based on sound levels or voice activity information of the input sounds from the mobile devices of the attendees. FIG. 9A depicts a flowchart of a method, performed by the server 150, of determining a current speaker among attendees at a conference based on a sound level of an input sound of each mobile device according to one embodiment of the present disclosure. For illustration purposes, FIG. 9B shows a sound level diagram of input sounds of a subset of mobile devices, over a period of time.

According to one embodiment, the input sound information associated with an input sound captured at each mobile device includes a sound level of the input sound. The sound level indicates the energy or loudness of the sound and may be represented by amplitude, intensity, or the like, for example, measured in decibels. Each mobile device transmits the input sound information including the sound level to the server 150.

With reference to FIG. 9A, the receiving unit 340 of the server 150 receives the input sound information including the sound level from the mobile devices, at 910. The attendee determining unit 320 of the server 150 determines the attendees at the conference among all of the users of the plurality of mobile devices based on the input sound information from the mobile devices. The speaker determining unit 380 of the server 150 compares the sound levels associated with the input sound information from the mobile devices of the determined attendees, at 920, and determines a current speaker whose mobile device has the greatest sound level among the compared sound levels, at 930.

The current speaker may be determined periodically at predetermined time intervals. FIG. 9B shows sound level diagram of three mobile devices over four time intervals, T₁ to T₄. As shown, the sound level is indicated by the amplitude of the sound level and the speaker during each time interval is determined based on the amplitude and/or the duration within each interval. During the time interval T₁, the sound level amplitude of the first mobile device is largest and thus, the user of the first mobile device is determined to be a current speaker. In the time interval T₂, the user of the third mobile device is determined to be a current speaker since the sound level amplitude is largest for this device. Likewise, the user of the second mobile device is determined to be a current speaker during the time interval T₃ because the sound level amplitude for the second mobile device is the largest in this interval. Similarly, the user of the third mobile device is determined to be a current speaker during the time interval T₄ based on its sound level amplitude.

Based on the sound levels of the mobile devices, the server 150 generates conference information including information on the current speaker and transmits the conference information to the mobile devices of the attendees. Each mobile device that has received the conference information from the server 150 may display the information on the current speaker on its display unit.

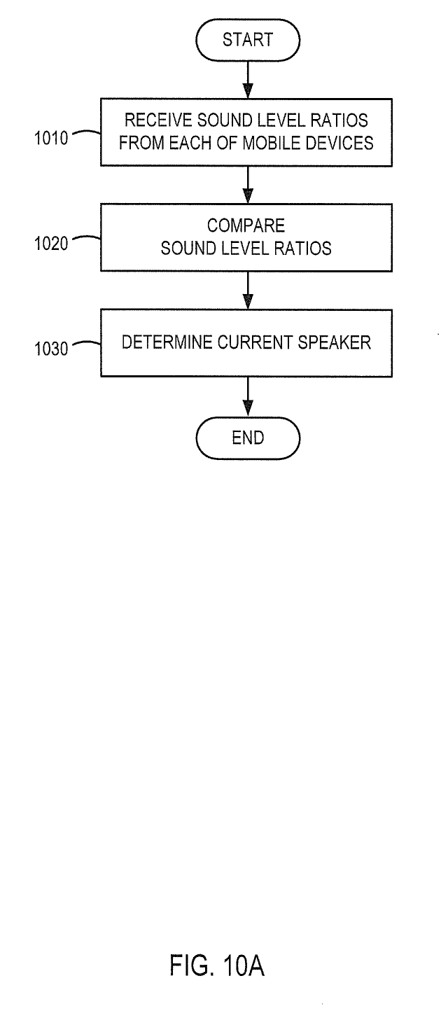

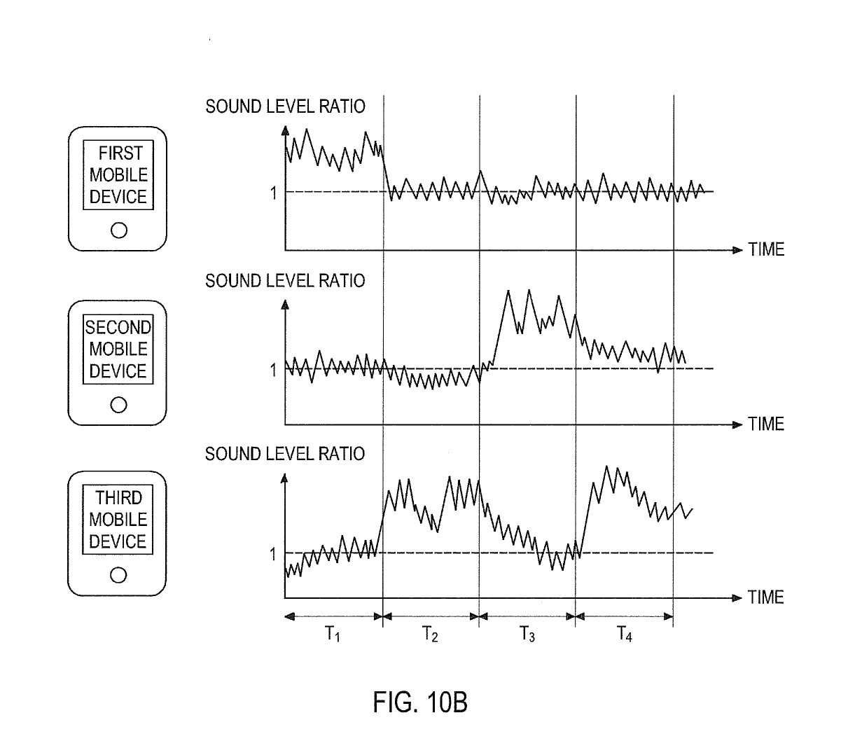

FIG. 10A illustrates a flowchart of a method, performed by the server 150, of determining a current speaker among attendees at a conference based on voice activity information according to one embodiment of the present disclosure. For illustration purposes, FIG. 10B shows a diagram of respective ratios of a current input sound level to an average input sound level of each of a subset of mobile devices, over a period of time.

In this embodiment, the input sound information associated with an input sound captured at each mobile device includes the voice activity information of the input sound. The voice activity information of each mobile device is determined from a ratio of a current input sound level to an average input sound level over a predetermined period of time. The ratio indicates the loudness of a current input sound at a given time in comparison with an average input sound over a predetermined period of time. The average input sound may represent a background sound or an ambient sound around a mobile device that has been continuously emanating from the surroundings of the mobile device and, therefore, the ratio may curb or get rid of the effect of the background sound in determining the current speaker. Each mobile device transmits the input sound information including voice activity information to the server 150.

With reference to FIG. 10A, the receiving unit 340 of the server 150 receives the input sound information including the voice activity information from the mobile devices, at 1010. The attendee determining unit 320 of the server 150 determines the attendees at the conference among all of the users of the plurality of mobile devices based on the input sound information from the mobile devices. The speaker determining unit 380 of the server 150 compares the sound level ratios associated with the input sound information from the mobile devices of the determined attendees, at 1020, and determines a current speaker whose mobile device has the greatest sound level ratio among the compared sound level ratios, at 1030.

The current speaker may be determined periodically at predetermined time intervals. FIG. 10B shows a sound level ratio diagram of three mobile devices over four time intervals, T₁ to T₄. As shown, the sound level ratio of each mobile device is indicated by the ratio of a current input sound level to an average input sound level over a predetermined period of time and the speaker during each time interval is determined based on the sound level ratio and/or the duration within each interval. During the time interval T₁, the sound level ratio of the first mobile device is largest and thus, the user of the first mobile device is determined to be a current speaker. In the time interval T₂, the user of the third mobile device is determined to be a current speaker since the sound level ratio is largest for this device. Likewise, the user of the second mobile device is determined to be a current speaker during the time interval T₃ because the sound level ratio for the second mobile device is the largest in this interval. Similarly, the user of the third mobile device is determined to be a current speaker during the time interval T₄ based on its sound level ratio.

Based on the sound level ratios of the mobile devices, the server 150 generates conference information including information on the current speaker and transmits the conference information to the mobile devices of the attendees. Each mobile device that has received the conference information from the server 150 may display the information on the current speaker on its display unit.

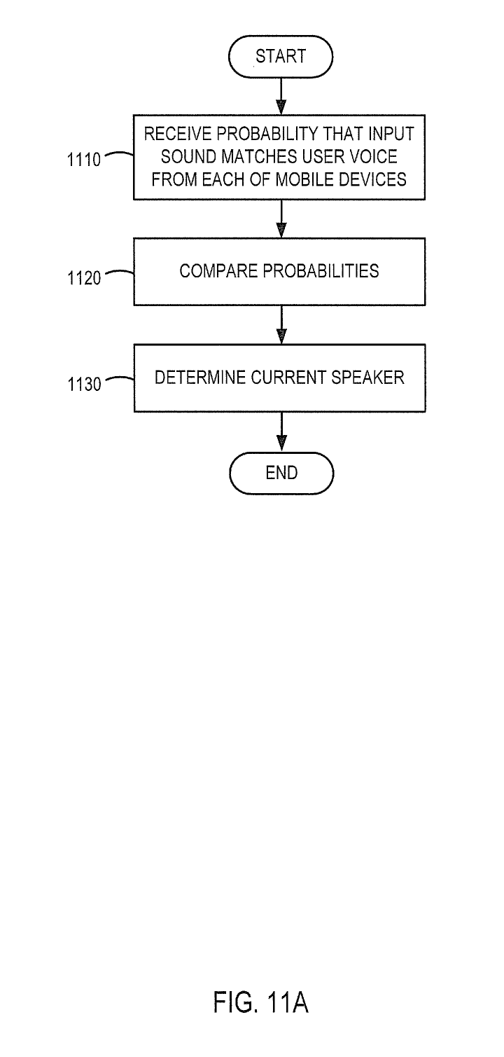

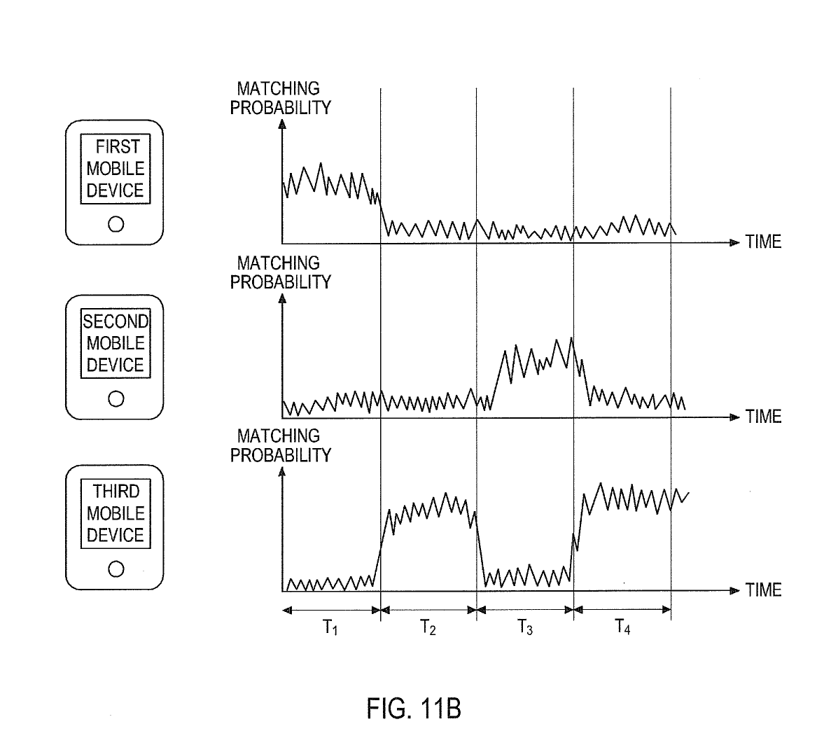

FIG. 11A illustrates a flowchart of a method, performed by the server 150, of determining a current speaker among attendees at a conference based on voice activity information according to one embodiment of the present disclosure. For illustration purposes, FIG. 11B illustrates a diagram of respective probabilities for a subset of mobile devices that an input sound of each mobile device matches acoustic characteristics of a voice of a user of the mobile device, over a period of time.

In this embodiment, the input sound information associated with an input sound captured at each mobile device includes the voice activity information of the input sound. The voice activity information of each mobile device is determined from a probability that an input sound of the mobile device matches acoustic characteristics of a voice of a user of the mobile device. The acoustic characteristics may be pre-stored in each mobile device. For example, a message displayed on a display unit of the mobile device prompts the user to read a predetermined phrase so that the voice of the user is stored in the mobile device and is processed to analyze and store the acoustic characteristics thereof. In one embodiment, an acoustic model representing the acoustic characteristics of the user's voice may be used. Specifically, a probability that the input sound corresponds to the acoustic model may be determined based on a degree of similarity between the input sound and the acoustic model. For example, the degree of similarity may be estimated based on a Euclidean distance between a vector representing the input sound and another vector representing the acoustic model. Each mobile device transmits the input sound information including voice activity information to the server 150.

With reference to FIG. 11A, the receiving unit 340 of the server 150 receives the input sound information including the voice activity information from the mobile devices, at 1110. The attendee determining unit 320 of the server 150 determines the attendees at the conference among all of the users of the plurality of mobile devices based on the input sound information from the mobile devices. The speaker determining unit 380 of the server 150 compares the probabilities associated with the input sound information from the mobile devices of the determined attendees, at 1120, and determines a current speaker whose mobile device has the greatest probability among the compared probabilities, at 1130.

The current speaker may be determined periodically at predetermined time intervals. FIG. 11B shows a matching probability diagram of three mobile devices over four time intervals, T₁ to T₄. As shown, the matching probability of each mobile device is indicated by a value of the matching probability over a predetermined period of time and the speaker during each time interval is determined based on the matching probability and/or the duration within each interval. During the time interval T₁, the matching probability of the first mobile device is largest and thus, the user of the first mobile device is determined to be a current speaker. In the time interval T₂, the user of the third mobile device is determined to be a current speaker since the matching probability is largest for this device. Likewise, the user of the second mobile device is determined to be a current speaker during the time interval T₃ because the matching probability for the second mobile device is the largest in this interval. Similarly, the user of the third mobile device is determined to be a current speaker during the time interval T₄ based on its matching probability.

Based on the matching probabilities of the mobile devices, the server 150 generates conference information including information on the current speaker and transmits the conference information to the mobile devices of the attendees. Each mobile device that has received the conference information from the server 150 may display the information on the current speaker on its display unit.

In one embodiment of the present disclosure, the server 150 calculates an arrangement of attendees at a conference based on a degree of similarity between the input sound information of each pair of the mobile devices of the attendees. It is assumed that N attendees with their mobile devices such as the mobile devices 160 and 162 participate in a conference at one specified location such as the location 110. The server 150 identifies the N attendees based on degrees of similarity between input sound information from the mobile devices. Further, the server 150 identifies the location of the N mobile devices based on location information transmitted from the N mobile devices. Each of the N mobile devices also transmits its input sound information to the server, and the attendee arrangement calculating unit 370 of the server 150 calculates an N×N matrix based on the input sound information from the N mobile devices. The input sound information from each mobile device includes the input sound of the mobile device and/or the sound signature of the input sound. The entry of the i-th row and the j-th column of the N×N matrix, which may be referred to be as a_{i,j}, may be calculated based on a degree of similarity between the input sound from the i-th mobile device and the input sound from the j-th mobile device of the N mobile devices. Although the above embodiment employs a degree of similarity, it should be appreciated that a degree of dissimilarity between the input sound information of each pair of the mobile devices of the attendees may be used interchangeably.

In some embodiments, the degree of similarity may be calculated based on a Euclidean distance between a vector representing the sound signature from the i-th mobile device and another vector representing the sound signature from the j-th mobile device. For example, the degree of similarity may be a value determined to be inversely proportional to the Euclidean distance, e.g., a reciprocal number of the Euclidean distance or a value of taking logarithm of the reciprocal number, whereas the degree of dissimilarity may be a value proportional to the Euclidean distance.

In one embodiment, each entry of the N×N matrix may be calculated based on a difference in a sound level between the input sounds of each pair of the N mobile devices. For example, the entry of the i-th row in the j-th column may be determined based on a difference or a ratio of the input sound level of the i-th mobile device with respect to that of the j-th mobile device.

After every entry of the N×N matrix is determined, the attendee arrangement calculating unit 370 transforms the N×N matrix to a 2×N matrix through a dimension reduction methodology such as PCA (principal component analysis), MDS (multidimensional scaling), or the like. Since the N×N matrix is, in general, a symmetric matrix, an Eigen decomposition process may be performed on the N×N matrix so that two largest eigenvectors constitute the 2×N matrix. Then, the two entries in each column of the 2×N matrix may be regarded as the x and y coordinates of a specified mobile device on a two-dimensional plane. For example, the two entries a_{1,j} and a_{2,j} in the j-th column of the 2×N matrix may be the x and y coordinates of the j-th mobile device on a two-dimensional plane.

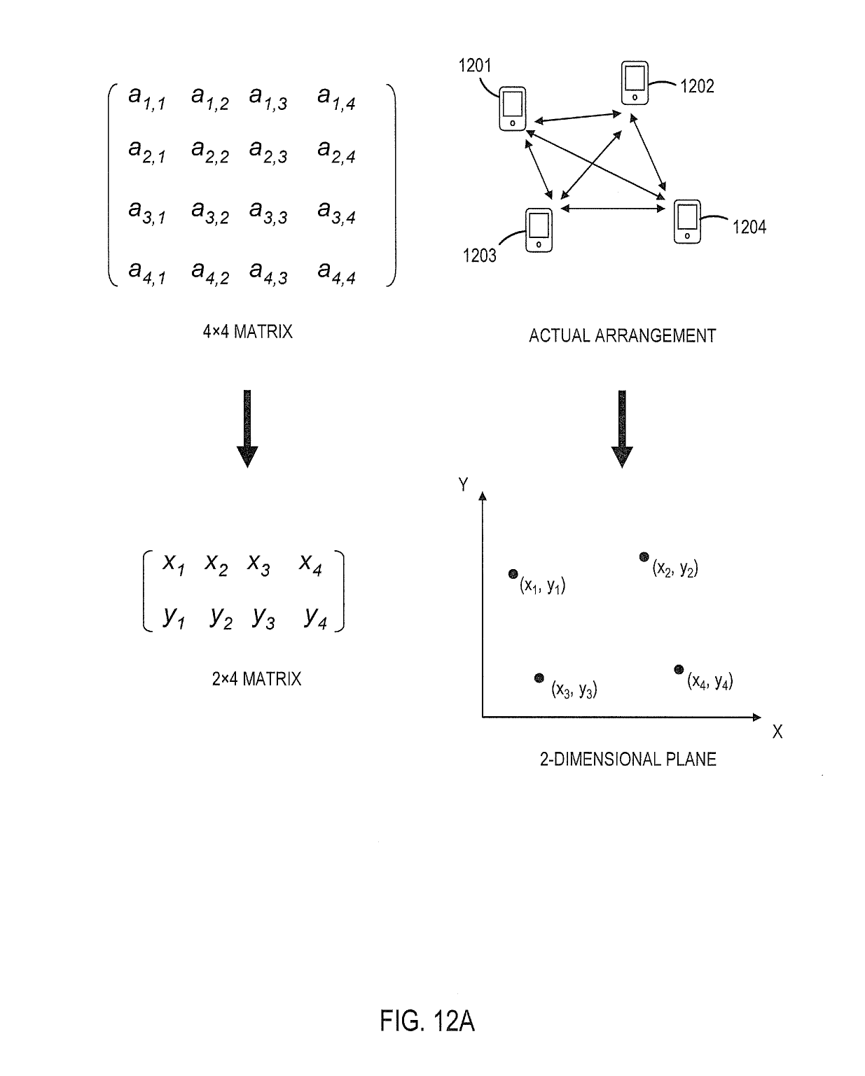

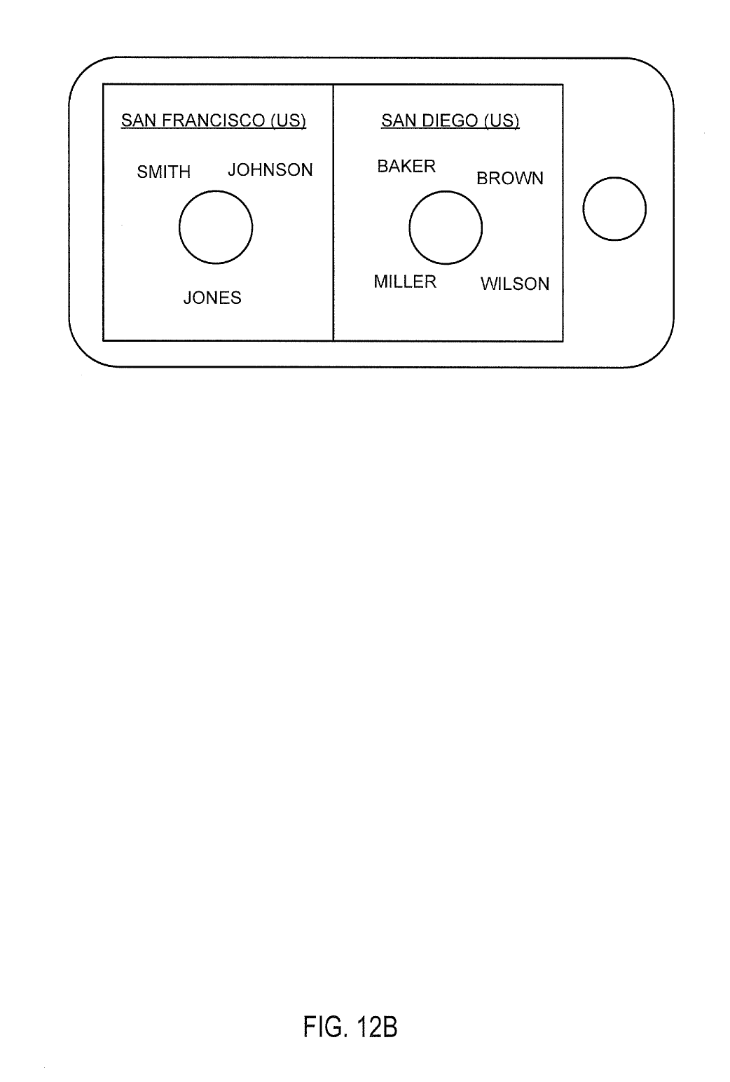

FIG. 12A depicts an exemplary arrangement of mobile devices 1201, 1202, 1203, and 1204 at a conference at a specified location and a similarity matrix for calculating the arrangement. The attendee arrangement calculating unit 370 calculates a 4×4 matrix based on the degree of similarity between the input sound information of each pair of the four mobile devices. Specifically, the entry a_{i,j} of the 4×4 matrix represents the degree of similarity between the input sound from the i-th mobile device and the input sound from the j-th mobile device. For example, the entry a_{1,3} represents the degree of similarity between the input sound from the mobile device 1201 and the input sound from the mobile device 1203.

After every entry is determined, the attendee arrangement calculating unit 370 transforms the 4×4 matrix to a 2×4 matrix, for example, using the above described methodology such as PCA or MDS. The entries in each column of the 2×4 matrix indicate the x and y coordinates of each mobile device on a two-dimensional plane. For example, the entries a_{1,1} and a_{2,1} may respectively indicate the x and y coordinates of the mobile device 1201, i.e., (x₁, y₁). The locations of the mobile devices are regarded as the locations of the attendees and thus the arrangement of the attendees can be represented on a two-dimensional plane as shown in FIG. 12A, based on the entries in the 2×4 matrix.

The arrangement on the two-dimensional plane shows relative positional relationships between the attendees. Thus, the actual arrangement of the attendees may be obtained through certain processes such as rotating, scaling, or flipping the arrangement represented on the two-dimensional plane with the x and y coordinates.

The server 150 generates conference information including information on the arrangement of the attendees calculated as above and transmits the conference information to each of the mobile devices of the attendees. The display unit of each mobile device may visually display the arrangement of the attendees as shown in FIG. 12B.

In one embodiment of the present disclosure, the log generating unit 360 of the server 150 generates a meeting log of a conference including attendee participation information. The attendee participation information includes a variety of activities of the attendees at the conference, e.g., when which attendee joins the conference, when which attendee is a current speaker at a particular time, when which attendee quits the conference, or the like.

Specifically, the attendee determining unit 320 of the server 150 determines that a new attendee has joined the conference based on the degree of similarity between the input sound from the mobile device of the new attendee and the input sound from each of the other mobile device of the other attendees. Then, the log generating unit 360 updates the log information, e.g., with the time when the new attendee has joined, identification of the new attendee, etc. Similarly, the attendee determining unit 320 of the server 150 also determines that one of the attendees at the conference has quit the conference based on the degree of similarity between the input sound from the mobile device of the quitting attendee and the input sound from each of the other mobile device of the other attendees. Then, the log generating unit 360 updates the log information, e.g., with the time when the attendee has quit, identification of the quitting attendee, etc. The log generating unit 360 further updates the log information, e.g., with identification of a current speaker at a given time.

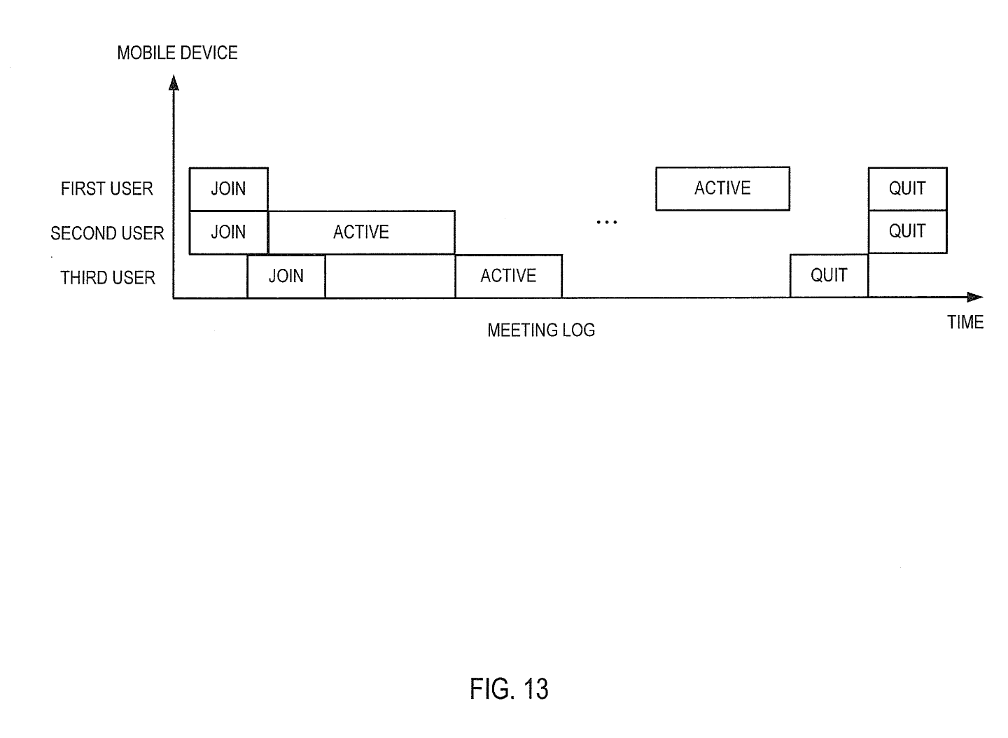

The log information may be generated in a form capable of representing a diagram as shown in FIG. 13. The log information of FIG. 13 represents that the first user and the second user firstly join the conference and subsequently the third user joins the conference. Further, the log information further represents the sequential current speakers, e.g., the second user followed by the third user. Furthermore, the log information represents that the third user firstly quits the conference and subsequently the first user and the second user quit the conference.

In some embodiments, the log information may include the total time that each attendee is determined as the current speaker. Further, the log information may further include the ratio of the total time as the current speaker to the entire conference time for each attendee.

The server 150 generates conference information including the log information generated in the manner as described above and transmits the conference information to each of the mobile devices of the attendees. The display unit of each of the mobile devices may display the log information.

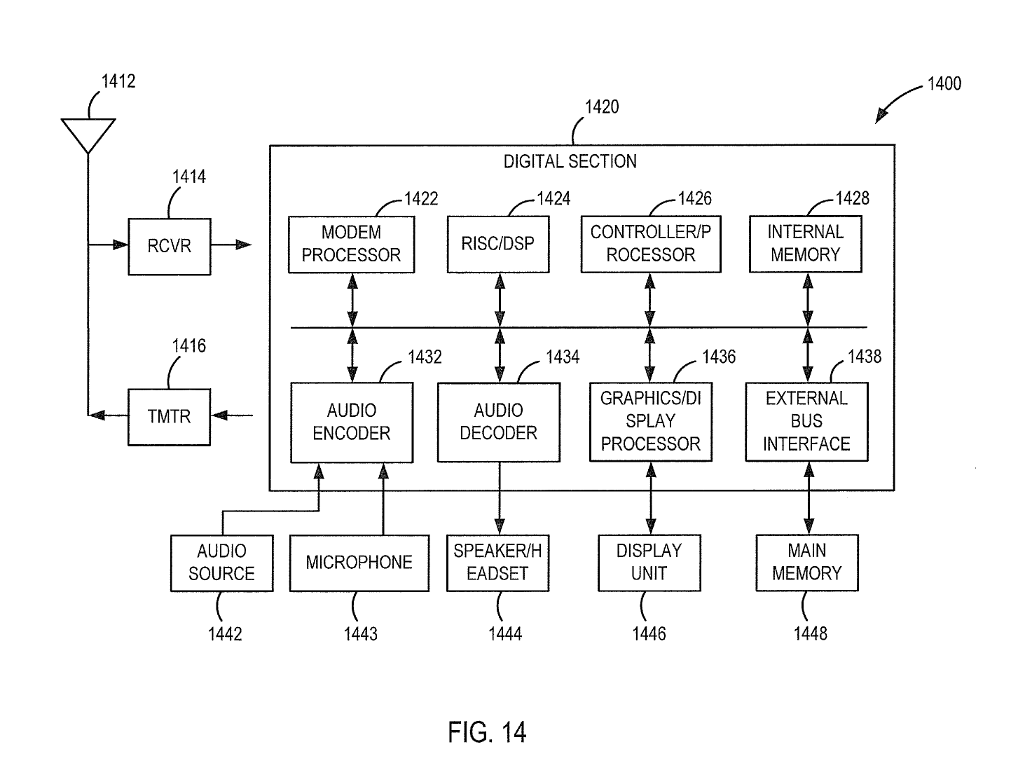

FIG. 14 shows a block diagram of a design of an exemplary mobile device 1400 in a wireless communication system. The configuration of the exemplary mobile device 1400 may be implemented in the mobile devices 160, 162, 164, 166, and 168. The mobile device 1400 may be a cellular phone, a terminal, a handset, a personal digital assistant (PDA), a wireless modem, a cordless phone, etc. The wireless communication system may be a Code Division Multiple Access (CDMA) system, a Global System for Mobile Communications (GSM) system, Wideband CDMA (WCDMA) system, Long Term Evolution (LTE) system, LTE Advanced system, etc. Further, the mobile device 1400 may communicate directly with another mobile device, e.g., using Wi-Fi Direct, Bluetooth, or FlashLinq technology.

The mobile device 1400 is capable of providing bidirectional communication via a receive path and a transmit path. On the receive path, signals transmitted by base stations are received by an antenna 1412 and are provided to a receiver (RCVR) 1414. The receiver 1414 conditions and digitizes the received signal and provides samples such as the conditioned and digitized digital signal to a digital section for further processing. On the transmit path, a transmitter (TMTR) 1416 receives data to be transmitted from a digital section 1420, processes and conditions the data, and generates a modulated signal, which is transmitted via the antenna 1412 to the base stations. The receiver 1414 and the transmitter 1416 may be part of a transceiver that may support CDMA, GSM, LTE, LTE Advanced, etc.

The digital section 1420 includes various processing, interface, and memory units such as, for example, a modem processor 1422, a reduced instruction set computer/digital signal processor (RISC/DSP) 1424, a controller/processor 1426, an internal memory 1428, a generalized audio encoder 1432, a generalized audio decoder 1434, a graphics/display processor 1436, and an external bus interface (EBI) 1438. The modem processor 1422 may perform processing for data transmission and reception, e.g., encoding, modulation, demodulation, and decoding. The RISC/DSP 1424 may perform general and specialized processing for the mobile device 1400. The controller/processor 1426 may perform the operation of various processing and interface units within the digital section 1420. The internal memory 1428 may store data and/or instructions for various units within the digital section 1420.

The generalized audio encoder 1432 may perform encoding for input signals from an audio source 1442, a microphone 1443, etc. The generalized audio decoder 1434 may perform decoding for coded audio data and may provide output signals to a speaker/headset 1444. The graphics/display processor 1436 may perform processing for graphics, videos, images, and texts, which may be presented to a display unit 1446. The EBI 1438 may facilitate transfer of data between the digital section 1420 and a main memory 1448.

The digital section 1420 may be implemented with one or more processors, DSPs, microprocessors, RISCs, etc. The digital section 1420 may also be fabricated on one or more application specific integrated circuits (ASICs) and/or some other type of integrated circuits (ICs).

In general, any device described herein may represent various types of devices, such as a wireless phone, a cellular phone, a laptop computer, a wireless multimedia device, a wireless communication personal computer (PC) card, a PDA, an external or internal modem, a device that communicates through a wireless channel, etc. A device may have various names, such as access terminal (AT), access unit, subscriber unit, mobile station, mobile device, mobile unit, mobile phone, mobile, remote station, remote terminal, remote unit, user device, user equipment, handheld device, etc. Any device described herein may have a memory for storing instructions and data, as well as hardware, software, firmware, or combinations thereof.

The techniques described herein may be implemented by various means. For example, these techniques may be implemented in hardware, firmware, software, or a combination thereof. Those ordinary skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, the various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

For a hardware implementation, the processing units used to perform the techniques may be implemented within one or more ASICs, DSPs, digital signal processing devices (DSPDs), programmable logic devices (PLDs), field programmable gate arrays (FPGAs), processors, controllers, micro-controllers, microprocessors, electronic devices, other electronic units designed to perform the functions described herein, a computer, or a combination thereof.

Thus, the various illustrative logical blocks, modules, and circuits described in connection with the disclosure herein may be implemented or performed with a general-purpose processor, a DSP, an ASIC, a FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

For a firmware and/or software implementation, the techniques may be embodied as instructions stored on a computer-readable medium, such as random access memory (RAM), read-only memory (ROM), non-volatile random access memory (NVRAM), programmable read-only memory (PROM), electrically erasable PROM (EEPROM), FLASH memory, compact disc (CD), magnetic or optical data storage device, or the like. The instructions may be executable by one or more processors and may cause the processor(s) to perform certain aspects of the functionality described herein.

If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, a server, or other remote source using a coaxial cable, fiber optic cable, twisted pair, digital subscriber line (DSL), or wireless technologies such as infrared, radio, and microwave, then the coaxial cable, the fiber optic cable, the twisted pair, the DSL, or wireless technologies such as infrared, radio, and microwave are included in the definition of medium. Disk and disc, as used herein, includes CD, laser disc, optical disc, digital versatile disc (DVD), floppy disk and blu-ray disc where disks usually reproduce data magnetically, while discs reproduce data optically with lasers. Combinations of the above should also be included within the scope of computer-readable media.

A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. Alternatively, the storage medium may be integral to the processor. The processor and the storage medium may reside in an ASIC. The ASIC may reside in a user terminal. Alternatively, the processor and the storage medium may reside as discrete components in a user terminal.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices may include PCs, network servers, and handheld devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for providing conference information in a mobile device, the method comprising:
monitoring, in the mobile device, one or more starting requirements of a conference at one or more locations;
transmitting input sound information from the mobile device to a server when the one or more starting requirements of the conference is detected;
receiving conference information from the server; and
displaying the conference information on the mobile device.

2. The method of claim 1, wherein the conference is a teleconference between two or more locations.

3. The method of claim 1, wherein the conference is at one location.

4. The method of claim 1, wherein the one or more starting requirements of the conference comprises at least one of a starting time of the conference, a location of the conference, and acoustic characteristics of a conference environment.

5. The method of claim 1, wherein the one or more starting requirements is detected when sound inputted into the mobile device corresponds to an acoustic characteristic of a conference environment.

6. The method of claim 1, wherein monitoring one or more starting requirements comprises pre-storing the one or more starting requirements of the conference in the mobile device.

7. The method of claim 1, wherein the conference information comprises information on attendees at the conference.

8. The method of claim 7, wherein the information on the attendees comprises at least one of identification and location of the attendees.

9. The method of claim 1, wherein the input sound information comprises a sound level of an input sound of the mobile device.

10. The method of claim 1, wherein the input sound information comprises voice activity information of the mobile device for determining a current speaker among attendees at the conference.

11. The method of claim 10, wherein the voice activity information comprises a ratio of a current input sound level to an average input sound level over a predetermined period of time of the mobile device.

12. The method of claim 10, wherein the voice activity information comprises a probability that an input sound of the mobile device matches acoustic characteristics of a voice of a user of the mobile device.

13. The method of claim 1, wherein the conference information comprises information on an arrangement of attendees at the conference.

14. The method of claim 1, wherein the conference information comprises a meeting log of the conference including attendee participation information.

15. A mobile device for providing conference information, comprising:
an initiating unit configured to monitor one or more starting requirements of a conference at one or more locations;
a transmitting unit configured to transmit input sound information to a server when the one or more starting requirements of the conference is detected;
a receiving unit configured to receive conference information from the server; and
a display unit configured to display the conference information.

16. The mobile device of claim 15, wherein the conference is a teleconference between two or more locations.

17. The mobile device of claim 15, wherein the conference is at one location.

18. The mobile device of claim 15, wherein the one or more starting requirements of the conference comprises at least one of a starting time of the conference, a location of the conference, and acoustic characteristics of a conference environment.

19. The mobile device of claim 15, wherein the one or more starting requirements is detected when sound inputted into the mobile device corresponds to an acoustic characteristic of a conference environment.

20. The mobile device of claim 15, wherein the one or more starting requirements of the conference is pre-stored in the mobile device.

21. The mobile device of claim 15, wherein the conference information comprises information on attendees at the conference.

22. The mobile device of claim 21, wherein the information on the attendees comprises at least one of identification and location of the attendees.

23. The mobile device of claim 15, wherein the input sound information comprises a sound level of an input sound of the mobile device.

24. The mobile device of claim 15, wherein the input sound information comprises voice activity information of the mobile device for determining a current speaker among attendees at the conference.

25. The mobile device of claim 24, wherein the voice activity information comprises a ratio of a current input sound level to an average input sound level over a predetermined period of time of the mobile device.

26. The mobile device of claim 24, wherein the voice activity information comprise a probability that an input sound of the mobile device matches acoustic characteristics of a voice of a user of the mobile device.

27. The mobile device of claim 15, wherein the conference information comprises information on an arrangement of attendees at the conference.

28. The mobile device of claim 15, wherein the conference information comprises a meeting log of the conference including attendee participation information.

29. A mobile device for providing conference information, comprising:
initiating means for monitoring one or more starting requirements of a conference at one or more locations;
transmitting means for transmitting input sound information to a server when the one or more starting requirements of the conference is detected;
receiving means for receiving conference information from the server; and
displaying means for displaying the conference information.

30. The mobile device of claim 29, wherein the conference is a teleconference between two or more locations.

31. The mobile device of claim 29, wherein the conference is at one location.

32. The mobile device of claim 29, wherein the one or more starting requirements of the conference comprises at least one of a starting time of the conference, a location of the conference, and acoustic characteristics of a conference environment.

33. The mobile device of claim 29, wherein the one or more starting requirements is detected when sound inputted into the mobile device corresponds to an acoustic characteristic of a conference environment.

34. The mobile device of claim 29, wherein the one or more starting requirements of the conference is pre-stored in the mobile device.

35. The mobile device of claim 29, wherein the conference information comprises information on attendees at the conference.

36. The mobile device of claim 35, wherein the information on the attendees comprises at least one of identification and location of the attendees.

37. The mobile device of claim 29, wherein the input sound information comprises a sound level of an input sound of the mobile device.

38. The mobile device of claim 29, wherein the input sound information comprises voice activity information of the mobile device for determining a current speaker among attendees at the conference.

39. The mobile device of claim 38, wherein the voice activity information comprises a ratio of a current input sound level to an average input sound level over a predetermined period of time of the mobile device.

40. The mobile device of claim 38, wherein the voice activity information comprise a probability that an input sound of the mobile device matches acoustic characteristics of a voice of a user of the mobile device.

41. The mobile device of claim 29, wherein the conference information comprises information on an arrangement of attendees at the conference.

42. The mobile device of claim 29, wherein the conference information comprises a meeting log of the conference including attendee participation information.

43. A computer-readable medium comprising instructions for providing conference information, the instructions causing a processor to perform the operations of:
monitoring, in a mobile device, one or more starting requirements of a conference at one or more locations;
transmitting input sound information from the mobile device to a server when the one or more starting requirements of the conference is detected;
receiving conference information from the server; and
displaying the conference information on the mobile device.

44. The medium of claim 43, wherein the conference is a teleconference between two or more locations.

45. The medium of claim 43, wherein the conference is at one location.

46. The medium of claim 43, wherein the one or more starting requirements of the conference comprises at least one of a starting time of the conference, a location of the conference, and acoustic characteristics of a conference environment.

47. The medium of claim 43, wherein the one or more starting requirements is detected when sound inputted into the mobile device corresponds to an acoustic characteristic of a conference environment.

48. The medium of claim 43, wherein monitoring one or more starting requirements comprises pre-storing the one or more starting requirements of the conference in the mobile device.

49. The medium of claim 43, wherein the conference information comprises information on attendees at the conference.

50. The medium of claim 49, wherein the information on the attendees comprises at least one of identification and location of the attendees.

51. The medium of claim 43, wherein the input sound information comprises a sound level of an input sound of the mobile device.

52. The medium of claim 43, wherein the input sound information comprises voice activity information of the mobile device for determining a current speaker among attendees at the conference.

53. The medium of claim 52, wherein the voice activity information comprises a ratio of a current input sound level to an average input sound level over a predetermined period of time of the mobile device.

54. The medium of claim 52, wherein the voice activity information comprises a probability that an input sound of the mobile device matches acoustic characteristics of a voice of a user of the mobile device.

55. The medium of claim 43, wherein the conference information comprises information on an arrangement of attendees at the conference.

56. The medium of claim 43, wherein the conference information comprises a meeting log of the conference including attendee participation information.

57. A method for providing conference information in a system having a server and a plurality of mobile devices, the method comprising:
monitoring, by one or more mobile devices, one or more starting requirements of a conference at one or more locations;
transmitting input sound information from each mobile device to the server when the one or more starting requirements of the conference is detected;
generating, by the server, conference information based on the input sound information from each mobile device;
transmitting the conference information from the server to each mobile device; and
displaying the conference information on each mobile device.

58. The method of claim 57, wherein the conference is a teleconference between two or more locations.

59. The method of claim 57, wherein the conference is at one location.

60. The method of claim 57, wherein the one or more starting requirements of the conference comprises at least one of a starting time of the conference, a location of the conference, and acoustic characteristics of a conference environment.

61. The method of claim 57, wherein the one or more starting requirements is detected when sound inputted into each mobile device corresponds to an acoustic characteristic of a conference environment.

62. The method of claim 57, wherein monitoring one or more requirements comprises pre-storing the one or more starting requirements of the conference in each mobile device.

63. The method of claim 57, wherein the conference information comprises information on attendees at the conference.

64. The method of claim 63, wherein the information on the attendees comprises at least one of identification and location of the attendees.

65. The method of claim 57, wherein the input sound information comprises a sound level of an input sound from each mobile device, and
wherein generating conference information comprises determining a current speaker among attendees at the conference based on the sound levels from the one or more mobile devices.

66. The method of claim 57, wherein the input sound information comprises voice activity information from each mobile device, and
wherein generating conference information comprises determining a current speaker among attendees at the conference based on the voice activity information from the one or more mobile devices.

67. The method of claim 66, wherein the voice activity information from each mobile device comprises a ratio of a current input sound level to an average input sound level over a predetermined period of time.

68. The method of claim 66, wherein the voice activity information from each mobile device comprises a probability that an input sound matches acoustic characteristics of a voice of a user of the mobile device.

69. The method of claim 57, wherein the conference information comprises information on an arrangement of attendees at the conference.

70. The method of claim 69, wherein the arrangement of the attendees at the conference is determined based on a degree of similarity of the input sound information between each pair of the one or more mobile devices.

71. The method of claim 57, wherein the conference information comprises a meeting log of the conference including attendee participation information.

72. The method of claim 57, wherein the input sound information from each of the one or more mobile devices comprises an input sound, and
wherein generating conference information comprises:
determining, by the server, a degree of similarity of the input sounds between each pair of the one or more mobile devices; and
determining, by the server, mobile devices of attendees at the conference based on the degrees of similarity.

73. The method of claim 72, wherein the mobile devices of the attendees are determined based on whether the degrees of similarity are greater than a predetermined threshold.

74. A computer-readable storage medium comprising instructions for providing conference information in a system having a server and a plurality of mobile devices, the instructions causing a processor to perform the operations of:
monitoring, by one or more mobile devices, one or more starting requirements of a conference at one or more locations;
transmitting input sound information from each mobile device to the server when the one or more starting requirements of the conference is detected;
generating, by the server, conference information based on the input sound information from each mobile device;
transmitting the conference information from the server to each mobile device; and
displaying the conference information on each mobile device.

75. The medium of claim 74, wherein the conference is a teleconference between two or more locations.

76. The medium of claim 74, wherein the conference is at one location.

77. The medium of claim 74, wherein the one or more starting requirements of the conference comprises at least one of a starting time of the conference, a location of the conference, and acoustic characteristics of a conference environment.

78. The medium of claim 74, wherein the one or more starting requirements is detected when sound inputted into each mobile device corresponds to an acoustic characteristic of a conference environment.

79. The medium of claim 74, wherein monitoring one or more requirements comprises pre-storing the one or more starting requirements of the conference in each mobile device.

80. The medium of claim 74, wherein the conference information comprises information on attendees at the conference.

81. The medium of claim 80, wherein the information on the attendees comprises at least one of identification and location of the attendees.

82. The medium of claim 74, wherein the input sound information comprises a sound level of an input sound from each mobile device, and
wherein generating conference information comprises determining a current speaker among attendees at the conference based on the sound levels from the one or more mobile devices.

83. The medium of claim 74, wherein the input sound information comprises voice activity information from each mobile device, and
wherein generating conference information comprises determining a current speaker among attendees at the conference based on the voice activity information from the one or more mobile devices.

84. The medium of claim 83, wherein the voice activity information from each mobile device comprises a ratio of a current input sound level to an average input sound level over a predetermined period of time.

85. The medium of claim 83, wherein the voice activity information from each mobile device comprises a probability that an input sound matches acoustic characteristics of a voice of a user of the mobile device.

86. The medium of claim 74, wherein the conference information comprises information on an arrangement of attendees at the conference.

87. The medium of claim 86, wherein the arrangement of the attendees at the conference is determined based on a degree of similarity of the input sound information between each pair of the one or more mobile devices.

88. The medium of claim 74, wherein the conference information comprises a meeting log of the conference including attendee participation information.

89. The medium of claim 74, wherein the input sound information from each of the one or more mobile devices comprises an input sound, and
wherein generating conference information comprises:
determining, by the server, a degree of similarity of the input sounds between each pair of the one or more mobile devices; and
determining, by the server, mobile devices of attendees at the conference based on the degrees of similarity.

90. The medium of claim 89, wherein the mobile devices of the attendees are determined based on whether the degrees of similarity are greater than a predetermined threshold.
